(19) United States
(12) Patent Application Publication
(10) Pub. No.: US 2011/0085026 A1
(43) Pub. Date: Apr. 14, 2011

(54) DETECTION METHOD AND DETECTION SYSTEM OF MOVING OBJECT

(76) Inventors: Ming-Hwei PERNG, Hsinchu City (TW); Yan-Fang Fan, Pingtung County (TW)

(21) Appl. No.: 12/860,110

(22) Filed: Aug. 20, 2010

(30) Foreign Application Priority Data
Oct. 12, 2009 (TW) 098134481

(51) Int. Cl. H04N 13/02; G06K 9/00

(52) U.S. Cl. 348/49; 382/103; 348/E13.074

(57) ABSTRACT

A detection method of a moving object is provided. The method includes: using a left lens system to capture a first and a second left image, and using a right lens system to capture a first right image and a second right image; subdividing the first right image into plural color blocks; selecting N control points on the first left image, and searching M first corresponding points in the first right image; calculating first depth information according to the control points and the first corresponding point, and calculating a possible area in the second right image to search P second corresponding points; using the first corresponding points and the second corresponding points to calculate a two-dimensional planar conversion parameter, and converting pixels in the color block to new positions to obtain a converted image; and identifying a difference area between the second right image and the converted image as an area.

### CROSS-REFERENCE TO RELATED APPLICATION

This application claims the benefit of Taiwan Patent Application No. 098134481, filed on Oct. 12, 2009, which is hereby incorporated by reference for all purposes as if fully set forth herein.

### BACKGROUND OF THE INVENTION

1. Field of Invention

The invention relates to a detection method and a detection system of a moving object, and more particularly to a detection method and a detection system for detecting a position of a moving object and information about a distance from the moving object to a camera body, in which a movable stereo camera including a left lens system and a right lens system is used as a photography device, and influences of a still background in an input image caused by ego-motion of the stereo camera are eliminated through image processing methods such as color information and feature matching.

2. Related Art

The conventional detection technology of a moving object is mainly applied to a building surveillance system. As a fixed camera is used and the still background remains unchanged in the picture in a period of time, a background model can be conveniently established by the surveillance system, the unchanged still background area in the picture can be removed through a frame difference or background subtraction method, and the residual area after the removal is an area in which the moving object is located.

However, when the algorithm used in the surveillance system is applied to a movable device system such as a navigation system for the blind or an anti-collision system for vehicles, the still background in a series of pictures shot by the camera will change due to the ego-motion of the camera. Thus, a still object can not be distinguished from the moving object in the pictures, and at the same time the background model cannot be established.

In the prior art, according to some documents, a single conversion parameter (for example, a background compensation parameter) is used for the entire image, while the influence of the depth (that is, a distance from a scene to the camera) and different positions of the scene in the picture are not considered, so that good background compensation cannot be achieved. In addition, in other documents, different compensation effects are achieved according to different depths through an enormous amount of calculation; however, as the calculation amount is too large, the requirements for real-time operation cannot be satisfied.

### SUMMARY OF THE INVENTION

Accordingly, in one aspect, the invention is directed to a detection method of a moving object, so as to solve the above problems.

According to an embodiment, the detection method of the invention is applied to a detection system, which includes a platform and a stereo camera including a left lens system and a right lens system disposed on the platform. The detection method includes the following steps. Firstly, the left lens system is used to capture a first left image and a second left image at a first time and a second time respectively, and the right lens system is used to capture a first right image and a second right image at the first time and the second time respectively; next, the first right image is subdivided into a plurality of color blocks; then, N control points are selected on the first left image, and M first corresponding points of the N control points on the first right image are searched, where M is a positive integer not greater than N because the corresponding points of some of the control points cannot be found.

Further, depth information is calculated according to each of the control points and the corresponding first corresponding point, and a possible area in the second right image in which the M first corresponding points appear is calculated according to the depth information; then, P second corresponding points of the M first corresponding points in the possible area are searched, where P is a positive integer not greater than M because the corresponding second corresponding points of some of the first corresponding points cannot be found; the first corresponding points and the corresponding second corresponding points contained in each color block are used to calculate a two-dimensional planar conversion parameter of a deformation of the color block generated from the first time to the second time, and the two-dimensional planar conversion parameter is used to convert all pixels in the color block to new positions; after all the color blocks are converted to the new positions, a converted image is obtained; finally, a plurality of difference areas between the second right image and the converted image is identified as an area in which the moving object is located.

In another aspect, the invention is directed to a detection system, for detecting a position of a moving object.

According to an embodiment, the invention provides a detection system, which includes a platform, a stereo camera including a left lens system and a right lens system, and a processing module. The left lens system is disposed on the platform, and captures a first left image and a second left image at a first time and a second time respectively; the right lens system is disposed on the platform, and captures a first right image and a second right image at the first time and the second time respectively.

Further, the processing module is connected to the left lens system and the right lens system respectively, for receiving the first left image, the second left image, the first right image, and the second right image. The processing module subdivides the first right image into a plurality of color blocks, selects N control points on the first left image, and searches M first corresponding points of the N control points in the first right image, where M is a positive integer not greater than N because the corresponding points of some of the control points cannot be found; then, the processing module calculates depth information according to each of the control points and the corresponding first corresponding point, and calculates a possible area in the second right image in which the M first corresponding points appear according to the depth information; then, the processing module searches P second corresponding points of the M first corresponding points in the possible area, where P is a positive integer not greater than M because the corresponding second corresponding points of some of the first corresponding points cannot be found; next, the processing module uses the first corresponding points and the second corresponding points contained in each color block to calculate a two-dimensional planar conversion parameter of a deformation of the color block generated from the first time to the second time, and uses the two-dimensional planar conversion parameter to convert all pixels in the color block to new positions to obtain a converted image; finally, the processing module identifies a difference area between the second right image and the converted image as an area in which the moving object is located.

Compared with the prior art, the detection method and the detection system of the invention can establish a depth diagram according to a few points and a small amount of calculation, and can provide an appropriate conversion parameter according to different positions of a scene, so as to achieve both fast and good compensation. Therefore, the detection method and the detection system of a moving object according to the invention have promising industrial application potential in the surveillance system market.

The advantages and spirit of the invention will be better understood with reference to the following detailed description and the accompanying drawings.

### BRIEF DESCRIPTION OF THE DRAWINGS

The invention will become more fully understood from the detailed description given herein below for illustration only, and thus are not limitative of the invention, and wherein:

FIG. 1 is a flow chart of a detection method of a moving object according to an embodiment of the invention;

FIG. 2 is a perspective view for detecting a moving object according to an embodiment of the invention; and

FIG. 3 is a perspective view of a detection system according to an embodiment of the invention.

FIGS. 4a and 4b show the results of the frame differencing method with and without searching conditions, respectively.

### DETAILED DESCRIPTION OF THE INVENTION

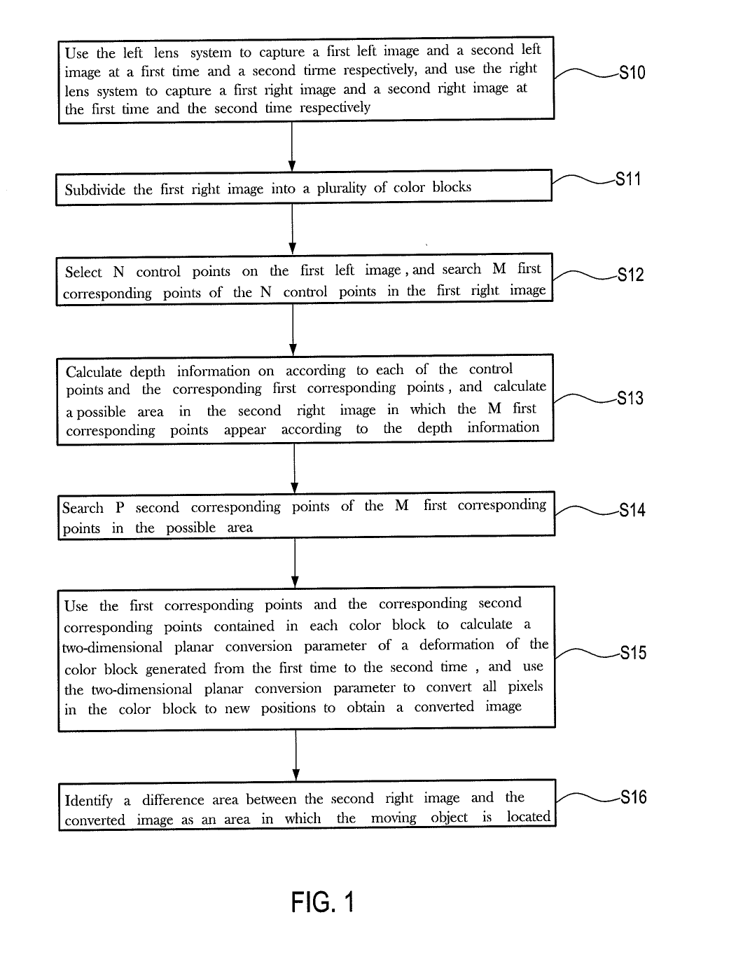

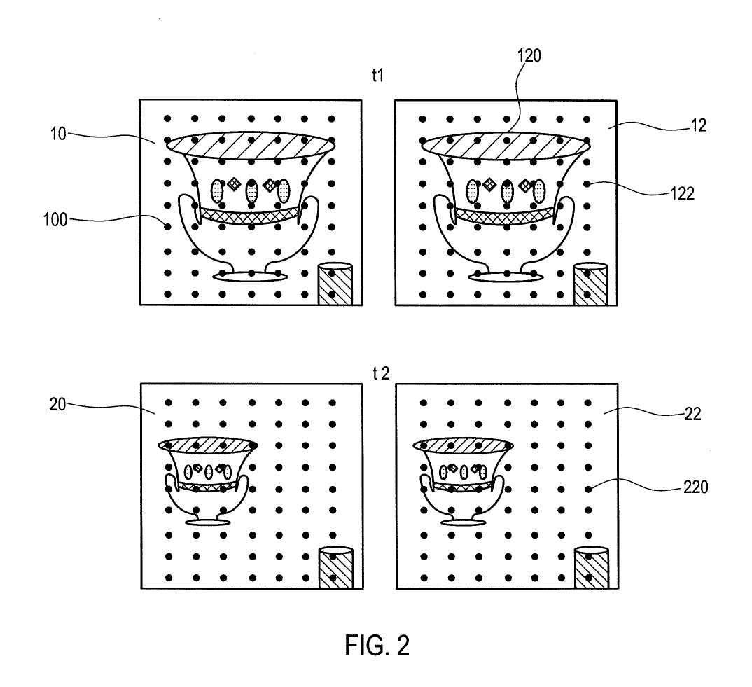

FIG. 1 is a flow chart showing steps of a detection method according to an embodiment of the invention, and FIG. 2 is a perspective view for detecting a moving object according to an embodiment of the invention. Referring to FIGS. 1 and 2, the detection method is applied to a detection system, which includes a platform and a stereo camera including a left lens system and a right lens system disposed on the platform.

According to an embodiment, the detection method includes the following steps. In Step S10, the left lens system 32 is used to capture a first left image 10 and a second left image 20 at a first time t1 and a second time t2 respectively, and the right lens system 34 is used to capture a first right image 12 and a second right image 22 at the first time t1 and the second time t2 respectively.

Further, in Step S11, the first right image 12 is subdivided into a plurality of color blocks 120 (only one clock block is shown here). Next, in Step S12, N control points 100 are selected on the first left image 10, and M first corresponding points 122 of the N control points 100 in the first right image 12 are searched, where M is a positive integer not greater than N.

In practice, a great amount of calculation results from searching the corresponding points 122 of the control points 100. Therefore, the invention uses the calibrated camera to reduce a search area from two dimensions to one dimension through Epipolar Constrain, so that the time for searching the first corresponding points 122 in the first right image 12 is shortened greatly. The Epipolar Constrain is a common technology in the prior art, and will not be described in detail herein.

In addition, in this embodiment, the N control points 100 are selected at a fixed interval in Step S12. For example, the control points 100 are selected at a fixed interval of 10 pixels. However, in actual applications, the N control points 100 may be selected according to factors such as experience accumulation, shooting scenes, image pixels, and special requirements at a non-fixed interval, and the selection mode is not limited to this embodiment.

Further, in Step S13, depth information is calculated according to each of the control points 100 and each of the M corresponding first corresponding points 122, and a possible area in the second right image 22 in which the M first corresponding points 122 appear is calculated according to the depth information. Here, the depth information is a distance of the control point 100 and the first corresponding point 122 relative to the platform, and the possible area is calculated according to the depth information in combination with a maximum speed of ego-motion of the platform in Step S13.

According to the conventional stereo camera parallax image technology, depth information of all pixels must be calculated. Taking an image having 640×480 pixels as an example, depth information values of 307200 pixels must be calculated, and even a great amount of calculation is required to obtain good object segmentation boundary. Therefore, in the invention, the image is subdivided into the color blocks, color edges are used as the object segmentation boundary, and several control points on each color block are used to represent the depth information of the color block. Taking the fixed interval of 10 pixels in this embodiment as an example, 2537 control points are involved in total, so that the number of points to be calculated is 0.8% of the original number, thus greatly reducing the amount of calculation.

Next, in Step S14, P second corresponding points 220 of the M first corresponding points 122 in the possible area are searched, where P is a positive integer not greater than M.

Similarly, a great amount of calculation also results from searching the second corresponding points 220 of the first corresponding points 122 in the possible area. However, as described above, in Step S12, the M first corresponding points 122 of the N control points 100 in the first right image 12 can be searched through the Epipolar Constrain; however, such constrain is not applicable to images with a time difference. Therefore, in Step S14, the possible area is used as a searching window, so as to reduce the search area substantially, and shorten the time for searching the second corresponding points 220.

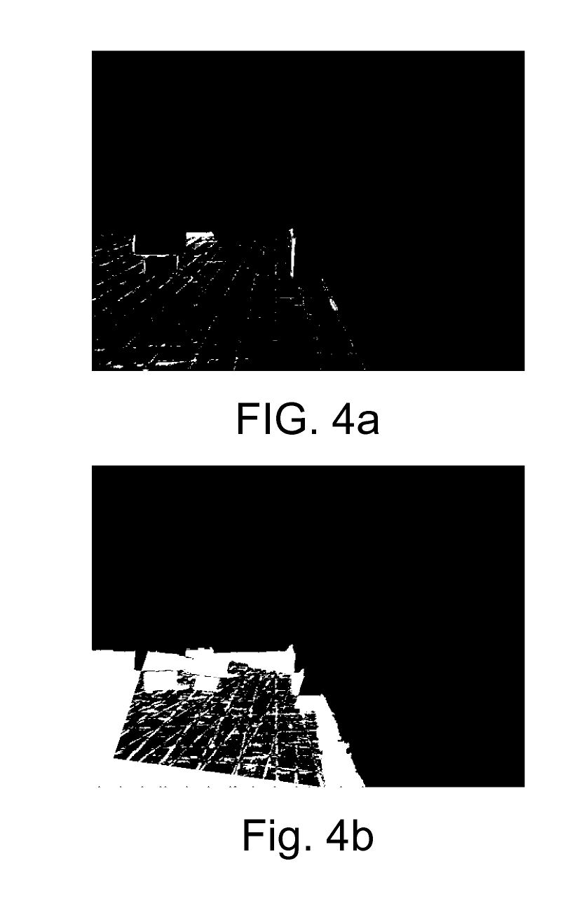

Reference is made to FIGS. 4a and 4b, which show the results of the frame differencing method with and without searching conditions, respectively. According to an embodiment, the tested area is only a block range on the ground (that is, the moving object does not exist), so that the ideal state of the test result is a black image (that is, no moving object is detected), and the ideal data has a high correct correspondence rate, short operation time, and the number of residual pixels being approximating 0. As shown in Table 1 and FIG. 4b, the data without the searching window has a low correct correspondence rate, a large operation amount, and poor performance (many residual pixels). On the contrary, as shown in Table 1 and FIG. 4a, the detection method using the searching window has a high operation speed and high correct rate.

TABLE 1
Comparison between the detection method using the searching
window and the detection method without using the searching
window according to the invention.

| | With Searching | Without Searching |
|---|---|---|
| | Conditions | Conditions |
| Correct | 34/35 = 97.143% | 21/39 = 53.846% |
| Correspondence | | |
| Rate | | |
| Operation Time | 7.142 sec | 1483.52 sec |
| Residual Pixels | 2410 pixels | 39511 pixels |

Reference is made to FIGS. 4a and 4b, which show the results of the frame differencing method with and without searching conditions, respectively.

Next, in Step S15, the first corresponding points 122 and the corresponding second corresponding points 220 contained in each color block 120 are used to calculate a two-dimensional planar conversion parameter of a deformation of the color block 120 generated from the first time t1 to the second time t2, and the two-dimensional planar conversion parameter is used to convert all pixels in the color block 120 to new positions to obtain a converted image.

According to this embodiment, the two-dimensional planar conversion parameter is used to calibrate the plurality of color blocks 120 from the first time t1 to the second time t2, so as to perform background compensation. In actual applications, the two-dimensional conversion parameter may be an affine conversion parameter, a translation conversion parameter, a rotation conversion parameter, or other appropriate conversion parameters.

Finally, in Step S16, a difference area between the second right image 22 and the converted image is identified as an area in which the moving object is located. In Step S16, an absolute value of a difference between the second right image 22 and the converted image is obtained through a transient difference method, and the difference area is screened according to a gray level threshold to obtain a monochrome image, so that a distinct contrast exists to indicate the area in which the moving object is located.

The gray level threshold screening is a common processing step in image processing, and the quality of the screening result affects the accuracy of subsequent processing. Normal screening algorithms include a maximum variance of between class method, a threshold screening iterative method, a maximum entropy method, a central cluster screening method, and a fuzzy threshold screening method, and the processed area includes global threshold screening and local threshold screening.

Normally, the gray level threshold screening is to convert an RGB image into a gray level mode, perform pixel histogram equalization for enhancing the contrast, and finally converts the gray level image into a binarized monochrome image according to a threshold for subsequent identification.

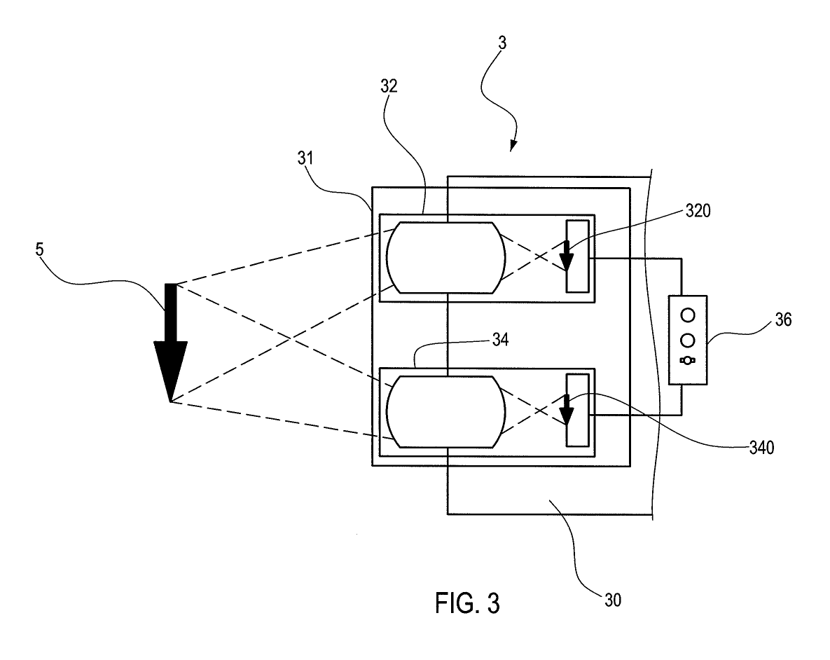

FIG. 3 is a perspective view of a detection system 3 according to an embodiment of the invention.

According to an embodiment, the detection system 3 of the invention is used to detect a position of a moving object 5. The detection system 3 includes a platform 30, a stereo camera 31 including a left lens system 32 and a right lens system 34, and a processing module 36.

Further, the left lens system 32 is disposed on the platform 30, and captures a first left image 320 and a second left image 320′ at a first time and a second time respectively; the right lens system 34 is disposed on the platform 30, and captures a first right image 340 and a second right image 340′ at the first time and the second time respectively.

Further, the processing module 36 is connected to the left lens system 32 and the right lens system 34 respectively, for receiving the first left image 320, the second left image 320′, the first right image 340, and the second right image 340′.

The processing module 36 subdivides the first right image 340 into a plurality of color blocks, selects N control points on the first left image 320, and searches M first corresponding points of the N control points in the first right image 340, where N and M are positive integers, and M is not greater than N. According to each of the control points and the corresponding first corresponding point, the processing module 36 calculates depth information, and calculates a possible area in the second right image 340′ in which the M first corresponding points appear according to the depth information. The processing module 36 searches P second corresponding points of the M first corresponding points in the possible area, where P is a positive integer not greater than M. Next, the processing module 36 uses the first corresponding points and the corresponding second corresponding points contained in each color block to calculate a two-dimensional planar conversion parameter of a deformation of the color block generated from the first time to the second time, and uses the two-dimensional planar conversion parameter to convert all pixels in the color block to new positions to obtain a converted image. The processing module 36 identifies a difference area between the second right image 340′ and the converted image as an area in which the moving object is located.

To sum up, the invention provides a detection method and a detection system for detecting a moving object on a moving platform based on motion vectors. The invention uses a movable and calibrated stereo camera as a photography device, eliminates influences of a still background in an input image caused by ego-motion of the camera through image processing methods such as color information and feature matching, and detects a position of a moving object and information about a distance from the moving object to a camera body

In the prior art, according to some documents, a single conversion parameter (for example, a background compensation parameter) is used for the entire image, while different from the invention, the influences of the depth (that is, a distance from a scene to the camera) and different positions of the scene in the picture are not considered, so that good background compensation cannot be achieved. In addition, in other documents, different compensation effects are achieved according to different depths through a great amount of calculation; however, as the calculation amount is too large, the requirements for real-time operation cannot be satisfied.

Compared with the prior art, the detection method and the detection system of the invention can establish a depth diagram with a few points and a small amount of calculation, and can provide an appropriate conversion parameter according to a different position of a scene, so as to achieve good compensation. Further, the searching window is proposed to substantially reduce the operation amount of time and increase a correct correspondence rate, thus realizing advantages of both a high speed and good compensation. Therefore, the detection method and the detection system of a moving object according to the invention have promising industrial application potential in the surveillance system market.

The detailed description of the above preferred embodiments is intended to make the features and spirits of the invention more comprehensible, rather than to limit the scope of the invention. On the contrary, various modifications or equivalent replacement shall fall within the appended claims of the invention. Therefore, the scope of the claims of the invention shall be construed in a most extensive way according to the above description, and cover all possible modifications and equivalent replacement.

What is claimed is:

1. A detection method of a moving object, applied to a detection system, wherein the detection system comprises a platform, a stereo camera including a left lens system and a right lens system disposed on the platform, and a processing module, the detection method comprises:
(a) using the left lens system to capture a first left image and a second left image at a first time and a second time respectively, and using the right lens system to capture a first right image and a second right image at the first time and the second time respectively;
(b) subdividing the first right image into a plurality of color blocks by the processing module;
(c) selecting N control points on the first left image, and searching M first corresponding points of the N control points in the first right image, wherein N and M are a positive integer respectively, and M is not greater than N by the processing module;
(d) calculating depth information according to each of the control points and the corresponding first corresponding point, and calculating a possible area in the second right image in which the M first corresponding points appear according to the depth information by the processing module;
(e) searching P second corresponding points of the M first corresponding points in the possible area, wherein P is a positive integer not greater than M by the processing module;
(f) using the first corresponding points and the second corresponding points contained in each color block to calculate a two-dimensional planar conversion parameter of a deformation of the color block generated from the first time to the second time, and using the two-dimensional planar conversion parameter to convert all pixels in the color block to new positions to obtain a converted image by the processing module; and
(g) identifying a difference area between the second right image and the converted image as an area in which the moving object is located by the processing module.

2. The detection method according to claim 1, wherein in (c), the N control points are selected at a fixed interval.

3. The detection method according to claim 1, wherein the depth information is a distance of the control point and the corresponding first corresponding point relative to the platform.

4. The detection method according to claim 1, wherein in (d), the possible area is calculated according to the depth information in combination with a maximum speed of ego-motion of the platform.

5. The detection method according to claim 1, wherein the two-dimensional planar conversion parameter is used to calibrate the plurality of color blocks from the first time to the second time to perform background compensation.

6. The detection method according to claim 1, wherein in (g), an absolute value of a difference between the second right image and the converted image is obtained through a transient difference method.

7. The detection method according to claim 6, wherein (g) further comprises:
(g1) screening the difference area according to a gray level threshold to obtain a monochrome image.

8. A detection system, for detecting a position of a moving object, comprising:
a platform;
a stereo camera including a left lens system, disposed on the platform, for capturing a first left image and a second left image at a first time and a second time respectively, and a right lens system, disposed on the platform, for capturing a first right image and a second right image at the first time and the second time respectively; and
a processing module, connected to the left lens system and the right lens system, for receiving the first left image, the second left image, the first right image, and the second right image, subdividing the first right image into a plurality of color blocks, selecting N control points on the first left image, and searching M first corresponding points of the N control points in the first right image, wherein N and M are a positive integer respectively, and M is not greater than N; for calculating depth information according to each of the control points and the corresponding first corresponding point, and calculating a possible area in the second right image in which the M first corresponding points appear according to the depth information; for searching P second corresponding points of the M first corresponding points in the possible area, wherein P is a positive integer not greater than M; for using the first corresponding points and the corresponding second corresponding points contained in each color block to calculate a two-dimensional planar conversion parameter of a deformation of the color block generated from the first time to the second time, and using the two-dimensional planar conversion parameter to convert all pixels in the color block to new positions to obtain a converted image; and for identifying a difference area between the second right image and the converted image as an area in which the moving object is located.

9. The detection system according to claim 8, wherein the processing module selects the N control points at a fixed interval.

10. The detection system according to claim 8, wherein the depth information is a distance of the control point and the corresponding first corresponding point relative to the platform.

11. The detection system according to claim 8, wherein the processing module calculates the possible area according to the depth information in combination with a maximum speed of ego-motion of the platform.

12. The detection system according to claim 8, wherein the two-dimensional planar conversion parameter is used to calibrate the plurality of color blocks from the first time to the second time to perform background compensation.

13. The detection system according to claim 8, wherein the processing module obtains an absolute value of a difference between the second right image and the converted image through a transient difference method.

14. The detection system according to claim 13, wherein the processing module further screens the difference area according to a gray level threshold to obtain a monochrome image.
